(19) United States
(12) Patent Application Publication
(10) Pub. No.: US 2006/0135227 A1
(43) Pub. Date: Jun. 22, 2006

(54) Sliding/folding combination type portable digital communication apparatus and hinge unit thereof

(75) Inventors: Yu-Chul Chang, Anyang-si (KR); Jong-Chul Shin, Suwon-si (KR); Seung-Chul Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/261,892

(22) Filed: Oct. 28, 2005

(30) Foreign Application Priority Data
Dec. 22, 2004 (KR) 10-2004-0110539

(51) Int. Cl. H04M 1/00

(52) U.S. Cl. 455/575.3

(57) ABSTRACT

Disclosed herein is a sliding/folding combination type portable digital communication apparatus that includes a body; a sliding folder having a first position in which it is constrained on the body, a second position in which it has slid a predetermined distance while continuously facing the body, and a third position in which it has rotated away from the body after the sliding in such a manner that it does not face the body; and a sliding hinge module positioned between the body and the sliding folder to travel together with the sliding folder and provide a force necessary for folding/unfolding the sliding folder. The user can conveniently use a single communication apparatus having the advantages of both sliding-type and folding-type apparatuses.

### PRIORITY

This application claims priority to an application entitled “Sliding/Folding Combination Type Portable Digital Communication Apparatus and Hinge Unit Thereof” filed with the Korean Intellectual Property Office on Dec. 22, 2004 and assigned Serial No. 2004-110539, the contents of which are incorporated herein by reference.

### BACKGROUND OF THE INVENTION

1. Field of the Invention

The present invention relates to digital communication apparatuses including cellular phones, PDAs (Personal Digital Assistants), HHPs (Hand Held Phones), camera phones, game phones, message transmission phones, and Internet phones, and more particularly to a portable digital communication apparatus having the advantages of both sliding-type and folding-type apparatuses and a hinge unit thereof.

2. Description of the Related Art

In general, “portable communication apparatus” refers to an electronic apparatus that a user can carry to perform wireless communication with a desired partner. To facilitate portability, designs of such portable communication apparatuses tend not only to be compact, slim, and light, but are also moving toward providing multimedia availability, having a wider variety of functions. In particular, future portable communication apparatuses are expected to incorporate greater multi-functionality and be capable of multi-purpose utilization, as well as to be more compact, light, and capable of being modified to be suitable for various multimedia or Internet environments. Additionally, portable communication apparatuses are now commonly used by people of all ages and all walks of life throughout the world, and are considered by some people as a nearly indispensable commodity which must be carried all the time.

A portable communication apparatus may be classified into various types according to its appearance, such as a bar-type portable communication apparatus, a flip-type portable communication apparatus, and a folder-type portable communication apparatus. The bar-type communication apparatus has a single housing shaped like a bar. The flip-type communication apparatus has a flip rotatably coupled to a bar-shaped housing by a hinge unit. The folder-type communication apparatus has a folder connected to a single bar-shaped housing by a hinge unit in such a manner that the folder can rotate to fold on or unfold from the housing.

Portable communication apparatuses may also be classified into a neck wearable type communication apparatus and a wrist wearable type communication apparatus according to the position or way in which a user puts on or wears the communication apparatus. The neck wearable type communication apparatus is worn around the user's neck using a string, and the wrist wearable type communication apparatus is worn around the user's wrist.

In addition, portable communication apparatus may be classified into a rotation-type communication apparatus and a sliding-type communication apparatus according to the manner of opening and closing the communication apparatus. In the rotation-type portable communication apparatus, two housings are coupled to each other in such a manner that one housing rotates to be opened or closed relative to the other, while they face each other. In the sliding-type portable communication apparatus, two housings are coupled to each other in such a manner that one housing slides along a longitudinal direction to be opened or closed relative to the other housing. These variously classified portable communication apparatuses can be easily understood by those skilled in the art.

Meanwhile, conventional portable communication apparatuses now tend to transmit data at a high speed in addition to performing the basic voice communication function. In other words, according to increased consumer demand, portable communication apparatuses now tend to provide a service using a wireless communication technology capable of transmitting data at a high speed.

Recent portable communication apparatuses also tend to be equipped with a camera lens to obtain video signals for transmission. In other words, current portable communication apparatuses have an external or embedded camera lens module which enables a user to perform video communication with a desired partner or to photograph a desired subject.

It is advantageous for a conventional sliding-type portable communication apparatus to include a large display unit, which, however, is unfavorable to compactness and slimness. Conventional folding-type communication apparatuses are advantageous to compactness and slimness, which are unfavorable to a large display unit. Therefore, a novel portable communication apparatus having the advantages of both sliding-type and folding-type apparatuses is necessary from the user's point of view.

### SUMMARY OF THE INVENTION

Accordingly, the present invention has been made to solve the above-mentioned problems occurring in the conventional terminals, and an object of the present invention is to provide a sliding/folding combination type portable digital communication apparatus capable of being opened/closed conveniently and a hinge unit thereof.

Another object of the present invention is to provide a portable digital communication apparatus combining the advantages of a sliding-type apparatus with those of a folding-type apparatus and a hinge unit thereof.

Yet another object of the present invention is to provide a portable digital communication apparatus having a semi-automatic sliding folder adapted to rotate to be opened only by a sliding motion and a hinge unit thereof.

Still another object of the present invention is to provide a portable digital communication apparatus adapted to be opened by a manual sliding motion and an automatic rotational motion and a hinge unit thereof.

Another object of the present invention is to provide a portable digital communication apparatus having a sliding hinge module and a hinge unit thereof.

In order to accomplish these objects, there is provided a portable digital communication apparatus including a body; a sliding folder having a first position in which it is constrained on the body, a second position in which it has slid a predetermined distance while continuously facing the body, and a third position in which it has rotated away from the body after the sliding in such a manner that it does not face the body; and a sliding hinge module positioned between the body and the sliding folder to travel together with the sliding folder and provide a force necessary for folding/unfolding the sliding folder.

In accordance with another aspect of the present invention, there is provided a portable digital communication apparatus including a body; a sliding folder adapted to slide while continuously facing the body and rotate up to a speech angle to be folded/unfolded; and a sliding hinge module for rotatably connecting the body and the sliding folder to each other and providing the sliding folder with a rotational force, wherein the sliding hinge module comprises: a hinge housing having a first region coupled to the body and a second region coupled to the sliding folder; a hinge shaft contained in the hinge housing; a hinge spring contained in the hinge shaft to provide a force necessary for opening the sliding folder by application of torsion; and a hinge pin contained in the hinge spring to constrain the hinge shaft and the hinge spring on the hinge housing with a fastener.

### BRIEF DESCRIPTION OF THE DRAWINGS

The above and other objects, features, and advantages of the present invention will be more apparent from the following detailed description taken in conjunction with the accompanying drawings, in which:

FIG. 1 is a perspective view showing a portable digital communication apparatus according to a preferred embodiment of the present invention;

FIG. 2 is a perspective view showing the portable digital communication apparatus, after a sliding folder has linearly traveled a predetermined distance, according to a preferred embodiment of the present invention;

FIG. 3 is a perspective view showing the portable digital communication apparatus, after the sliding folder has rotated, according to a preferred embodiment of the present invention;

FIG. 4 is a partial front view showing a mounting state of a sliding hinge module for rotatably constraining a body and the sliding folder of the portable digital communication apparatus according to a preferred embodiment of the present invention;

FIG. 5 is a perspective view showing the sliding hinge module, for coupling to a sliding folder, according to a preferred embodiment of the present invention;

FIG. 6 is a perspective view showing the sliding folder, to be coupled to the body, according to a preferred embodiment of the present invention;

FIG. 7 is another perspective view showing an interior of a lateral wall positioned on a body according to a preferred embodiment of the present invention;

FIG. 8 is a perspective view showing the exterior of an assembled sliding hinge module according to a preferred embodiment of the present invention; and

FIG. 9 is an exploded perspective view showing the construction of a sliding hinge module according to a preferred embodiment of the present invention.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein is omitted to avoid making the subject matter of the present invention unclear.

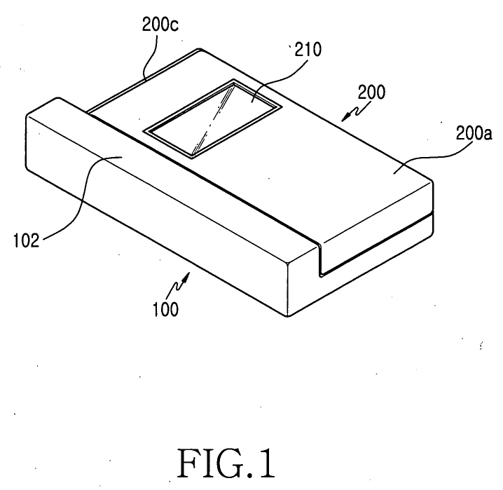

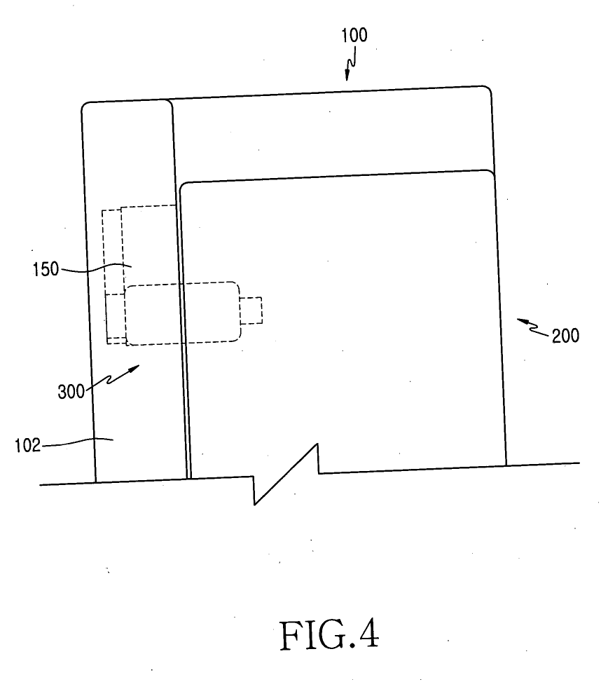

As shown in FIGS. 1 to 4, the portable digital communication apparatus according to the present invention is opened/closed by sliding and rotational motions. It should be noted that the inventive portable digital communication apparatus has combined the advantages of conventional sliding-type apparatuses with those of conventional folder-type apparatuses. The portable digital communication apparatus according to the present invention includes a body 100, a sliding folder 200 adapted to fold/unfold on/from the body 100, and a sliding hinge module 300 (shown in FIG. 4) positioned between the body 100 and the sliding folder 200 to constrain them in such a manner that they can slide and rotate. More particularly, the portable digital communication apparatus according to the present invention preferably includes an elongated bar-shaped body 100; a sliding folder 200 having a first position in which it is constrained on the body 100, a second position in which it has slid along a longitudinal direction of the body 100 while continuously facing the body 100, and a third position in which it has rotated away from the body 100 after the sliding, in such a manner that it does not face the body 100; and a sliding hinge module 300 (shown in FIG. 4) adapted to travel together with the sliding folder 200 and provide a force necessary for unfolding the sliding folder 200.

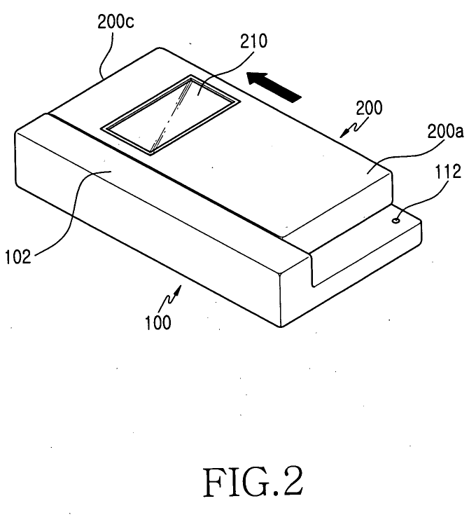

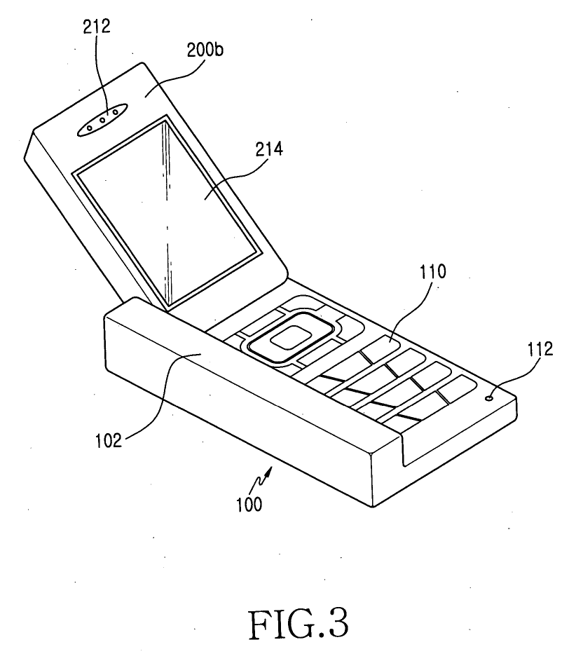

The first position corresponds to a state wherein the sliding folder 200 is completely folded on the body 100, as shown in FIG. 1. The second position corresponds to a state wherein the sliding folder 200 has slid away so that it is not constrained on the body 100, as shown in FIG. 2. The third position corresponds to a state wherein the sliding folder 200 has rotated a predetermined angle out of the constraint on the body 100, as shown in FIG. 3.

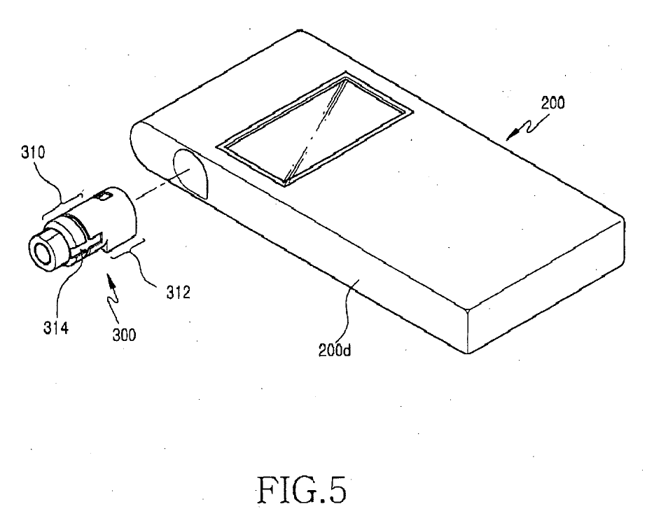

The body 100 has a number of keys 110 and a microphone device 112 positioned on an upper surface thereof. As shown in FIG. 3, the keys 110 and the microphone device 112 are preferably positioned adjacent to each other. The body 100 has a lateral wall 102 extending along an edge thereof while protruding vertically from the upper surface thereof. The lateral wall 102 continuously extends along the edge of the body 100 in a linear fashion. Therefore, a lateral surface 200b (shown in FIG. 5) of the sliding folder 200 rotates in a direction approaching or away from the inner surface 103 of the lateral wall 102 while facing it.

The sliding folder 200 has an auxiliary display device 210 positioned on the upper surface 200a thereof and a speaker device 212 and a main display device 214 positioned on a lower surface 200B thereof. The speaker device 212 and the main display device 214 are positioned adjacent to each other. Preferably, an end 200c of the sliding folder 200 has a predetermined radius of curvature for a smooth rotational motion.

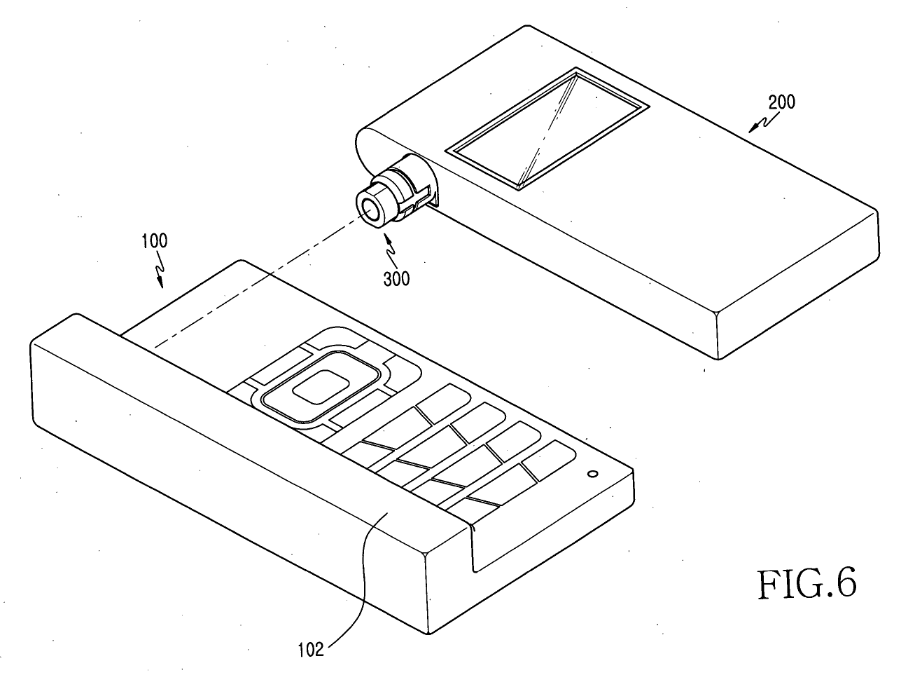

As shown in FIGS. 5 to 7, the portable digital communication apparatus according to the present invention preferably has a stopping mechanism for limiting the rotation of the sliding folder 200 in the first position. The stopping mechanism releases a stop condition as the sliding folder 200 slides. The stopping mechanism includes a first protrusion 120 formed in an opening 150 provided in the lateral wall 102 and a groove 314 formed on the sliding hinge module 300 to be coupled to the protrusion 120. The first protrusion 120 linearly extends in a direction perpendicular to the sliding direction of the sliding folder 200. The groove 314 linearly extends in a direction perpendicular to the sliding direction of the sliding folder 200. The opening 150 has a second protrusion 121 formed perpendicularl to the first protrusion 120 to be coupled to a first constraint groove 310a (described later) and slide the sliding folder 200 from the body 100.

The lateral wall 102 has a planar inner surface 103, which is provided with the opening 150 for sliding and rotational motions of the sliding hinge module 300. The opening 150 includes a groove 151 elongated along the longitudinal direction in which the lateral wall 102 extends. A part of the sliding hinge module 300 is coupled to the groove 151 for sliding and rotational motions.

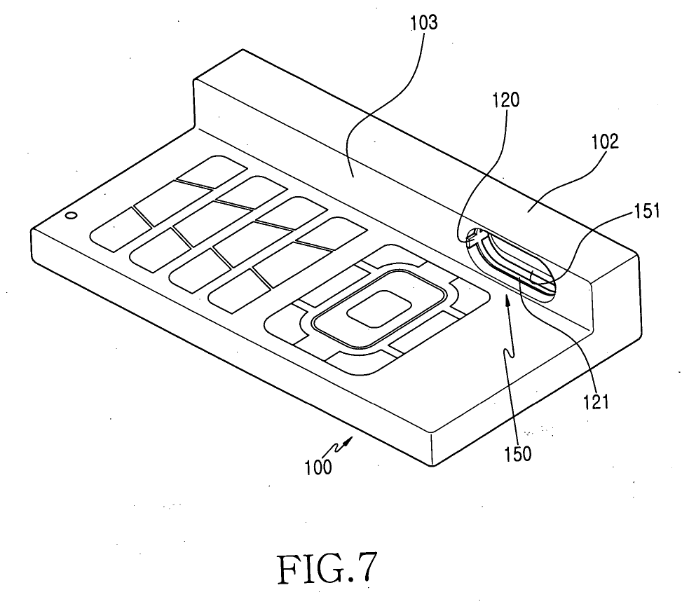

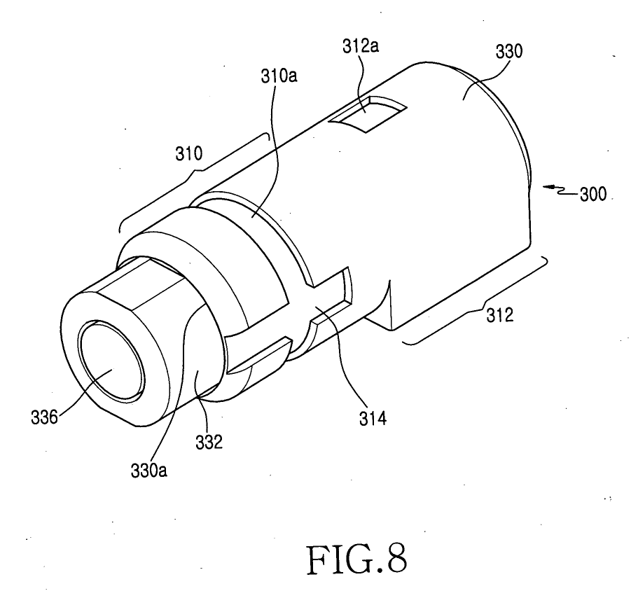

As shown in FIG. 8, the sliding hinge module 300, in particular the hinge housing 330 of the sliding hinge module includes a first region 310 coupled to the body 100 for sliding and rotational motions and a second region 312 coupled to the sliding folder 200. The first region 310 has a cylindrical contour, and the second region 320 preferably does not. The groove 314, which corresponds with one of the components of the stopping mechanism, is shown in FIG. 8 together with a hinge shaft 332 and a hinge pin 336, which will be described later. The hinge housing 330 of the sliding hinge module 300 is provided with first and second constraint grooves 310a and 312a to be constrained on the body and the sliding folder. The first and second constraint grooves 310a and 312a are positioned in the first and second regions 310 and 312, respectively. The first constraint groove 310a is coupled to the second protrusion 121 shown in FIG. 7 to constrain the sliding hinge module 300 on the body 100 in such a manner that it can slide and rotate, and the second constraint groove 312a is coupled to a hook (not shown) formed inside the body to constrain the sliding folder 200 on the body 100, so that the sliding folder 200 is connected to the body 100 by the sliding hinge module 300 in such a manner that it can slide and rotate.

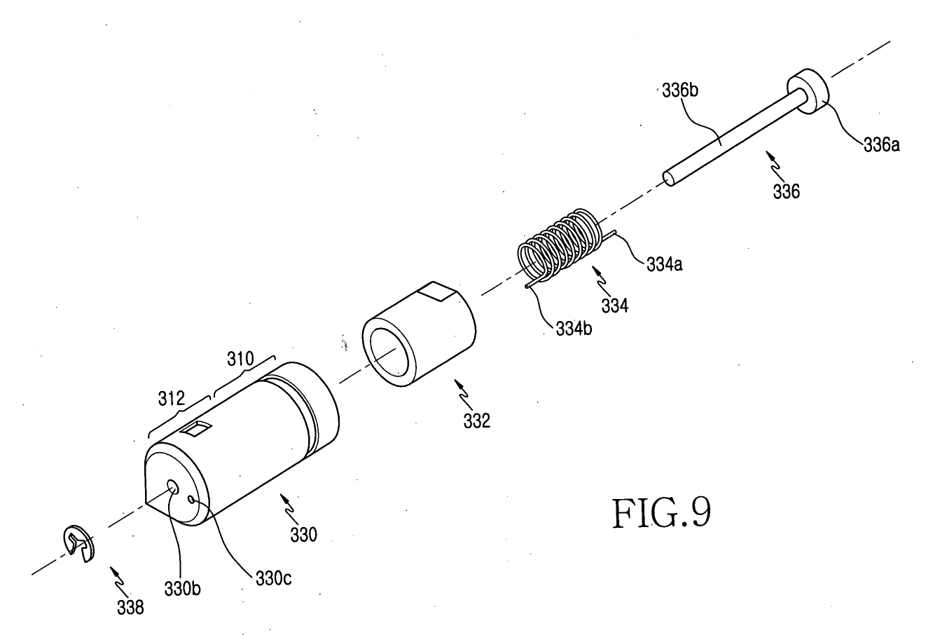

The construction of the sliding hinge module 300 will now be described in detail. As shown in FIG. 9, the sliding hinge module 300 used in the portable digital communication apparatus according to the present invention includes a hinge housing 330, a hinge shaft 332 contained in the hinge housing 330, a hinge spring 334 contained in the hinge shaft 332, a hinge pin 336 contained in the hinge spring 334, and a fastener 338 for constraining the hinge pin 336 on an end of the hinge housing 330 and closing the hinge shaft 332 and the hinge spring 334. The fastener 338 is preferably made up of an O-ring. The hinge spring 334 is preferably made up of a spring for providing a torsion force. Preferably, the sliding hinge module 300 includes a hinge housing 330, a hinge shaft 332 extending through the interior of the hinge housing 330, a hinge spring 334 extending through the interior of the hinge shaft 332, a hinge pin 336 extending through the interior of the hinge spring 334, and a fastener 338 for constraining the hinge pin 336 on an end of the hinge housing 330 and closing the hinge shaft 332 and the hinge spring 334.

The hinge housing 330 includes the first region 310 contained in the lateral wall 102 of the body and the second region 312 contained in the sliding folder 200. The first and second regions 310 and 312 are integral with each other. The hinge housing 330 has a groove 314 formed in the first region 310, which is coupled to the above-mentioned first protrusion 120 to constrain the rotation of the sliding folder 200. The hinge housing 330 has a first opening 330a (shown in FIG. 8) formed on an end thereof, to which the hinge shaft 332 is coupled, a second opening 330b (FIG. 9) formed on the other end thereof, into which the hinge pin 336 is inserted, and a third opening 330c to constrain an end 334b of the hinge spring 334.

The other end 334a of the hinge spring is contained in an end of the hinge shaft 332 and the large diameter portion 336a of the hinge pin 336 is inserted into the other end thereof. The end 334b of the hinge spring 334 is constrained in the third opening 330c of the hinge housing and the other end 334a thereof is constrained in the hinge shaft 332. The hinge pin 336 includes a large diameter portion 336a and a small diameter portion 336b integrally extending from the large diameter portion 336a. The large diameter portion 336a is inserted into the hinge shaft 332 and the small diameter portion 336b extends through the second opening 330b formed on the other end of the hinge housing and is constrained by fastener 338.

According to the above construction, the sliding hinge module 300 provides the sliding folder 200 with a rotational force, which is based on the restoration force of the hinge spring. An end of the hinge shaft 332 is rotatably constrained on the body.

As mentioned above, the present invention provides a portable digital communication apparatus having the advantages of both sliding-type and folding-type apparatuses. The inventive apparatus provides the user with a large-width display device and is semi-automatically opened/closed for convenience.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A portable digital communication apparatus comprising:
a body;
a sliding folder having a first position in which the folder is constrained on the body, a second position in which the folder has slid a predetermined distance while continuously facing the body, and a third position in which the folder has rotated away from the body after sliding in a manner not facing the body; and
a sliding hinge module positioned between the body and the folder to travel together with the folder and provide a force necessary for folding/unfolding the folder.

2. The portable digital communication apparatus as claimed in claim 1, wherein the body has a protruding lateral wall extending along an edge thereof.

3. The portable digital communication apparatus as claimed in claim 2, further comprising a stopping mechanism for limiting rotation of the folder in the first position.

4. The portable digital communication apparatus as claimed in claim 3, wherein the stopping mechanism comprises a protrusion formed on the lateral wall and a groove formed on the sliding hinge module to be coupled to the protrusion.

5. The portable digital communication apparatus as claimed in claim 4, wherein the protrusion extends in a direction perpendicular to a sliding direction of the folder.

6. The portable digital communication apparatus as claimed in claim 2, wherein the lateral wall has an opening for sliding of the sliding hinge module.

7. The portable digital communication apparatus as claimed in claim 6, wherein the opening comprises an elongated groove formed on an inner surface of the lateral wall.

8. The portable digital communication apparatus as claimed in claim 1, wherein a lateral surface of the folder rotates in a direction approaching or away from an inner surface of the lateral wall while facing the lateral wall.

9. The portable digital communication apparatus as claimed in claim 1, wherein the sliding hinge module comprises a first region coupled to the body for sliding and a second region coupled to the folder.

10. The portable digital communication apparatus as claimed in claim 1, further comprising a constraint means for connecting the folder to the body in such a manner that the folder can linearly slide the predetermined distance and rotate up to a predetermined angle.

11. A portable digital communication apparatus comprising:
a body;
a sliding folder adapted to slide while continuously facing the body and rotate up to a speech angle to be folded/unfolded; and
a sliding hinge module for rotatably connecting the body and the sliding folder to each other and providing the sliding folder with a rotational force, wherein the sliding hinge module comprises:
a hinge housing having a first region coupled to the body and a second region coupled to the sliding folder;
a hinge shaft contained in the hinge housing;
a hinge spring to provide a force for opening the sliding folder; and
a hinge pin to constrain the hinge shaft and the hinge spring on the hinge housing.

12. The portable digital communication apparatus as claimed in claim 11, wherein the hinge shaft extends through an interior of the hinge housing, the hinge spring extends through an interior of the hinge shaft to be contained therein, and the hinge pin extends through an interior of the hinge spring to be contained therein.

13. The portable digital communication apparatus as claimed in claim 11, wherein the hinge housing has a first opening formed on an end surface thereof to contain the hinge shaft, a second opening formed on an other end surface thereof, through which the hinge pin extends, and a third opening to constrain an end of the hinge spring.

14. The portable digital communication apparatus as claimed in claim 11, wherein an end of the hinge spring is constrained on the hinge housing and an other end thereof is constrained on the hinge shaft.

15. The portable digital communication apparatus as claimed in claim 11, wherein the hinge pin comprises a large diameter portion inserted into the hinge shaft and a small diameter portion extending from the large diameter portion with an end thereof constrained on an end of the hinge housing.

16. The portable digital communication apparatus as claimed in claim 11, wherein the hinge housing has a groove formed on an outer peripheral surface thereof.

17. The portable digital communication apparatus as claimed in claim 11, wherein the hinge spring is contained in the hinge shaft.

18. The portable digital communication apparatus as claimed in claim 11, wherein the hinge pin is contained in the hinge spring.

19. The portable digital communication apparatus as claimed in claim 11, wherein a fastener is used to constrain the hinge shaft and the hinge spring on the hinge housing.
